(19) United States
(12) Patent Application Publication
(10) Pub. No.: US 2010/0102753 A1
(43) Pub. Date: Apr. 29, 2010

(54) Circuit Arrangement and Method for the Dimming Control of One or More Operating Device for Lamps

(76) Inventor: Axel Pilz, Neuenstein (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/529,123

(22) PCT Filed: Feb. 28, 2007
(86) PCT No.: PCT/EP2007/051880

§ 371 Date: Aug. 28, 2009

(51) Int. Cl. H05B 37/02

(52) U.S. Cl. 315/295

(57) ABSTRACT

A circuit arrangement for dimming control of one or more operating devices (3) for luminous means (4), the operating device (3) being controlled in the single pushbutton operation by one pushbutton (T1) which conducts line voltage (L) via a control line (5) to a control terminal (1) of the operating device (3), and switching and dimming functions of the operating device (3) can be executed by this pushbutton (T1), wherein a second pushbutton (T2) is connected to the control line (5) via a diode (D1), and the control device (3) is then controlled in a two pushbutton operation by two pushbuttons.

### TECHNICAL FIELD

The invention relates to electronic operating devices for luminous means that are suitable for dimming these luminous means.

### PRIOR ART

There are very varied approaches to achieving the dimming of luminous means. For larger illumination systems, there has, on the one hand, already been for a very long time an analogue interface that displays the respective dimming state via an analog voltage of 1 to 10 V. On the other hand, there is a newer digital interface with which the most varied complex illumination tasks can be solved. Two methods have in common the disadvantage that use is made for this purpose of control units that then drive the electronic operating device.

For relatively simple installations, for example in domestic operation, there are simpler methods that aim at controlling the operating device autonomously with only one on/off switch. The so called on-switch dimming, for example, could be named here. The dimming function is started here by means of the light switch by the switching operation of “on/off/on”. Once the desired dimming value is reached, the latter is stored by “off”. When switching on next occurs, the stored dimming value is automatically reset.

A further method is the so-called three-stage dimming, which has a wide use chiefly in the NAFTA area. Here, two electronic operating devices are used in one luminaire. The luminaire is driven in two phases. Depending on which phase is switched on, it is possible to implement three dimming stages, in which case the operating devices are driven either individually or in common. The operating devices must therefore have different powers and must also be capable of operating with one luminous means.

A further known dimming method is the touch DIM method, which has found wide use. Here, the electronic operating devices are permanently connected to the line voltage and switched on and off via a control input. Use is made to this end of a pushbutton with a make contact element, an outer conductor of the line voltage being conducted via the pushbutton to a terminal of the operating device. As long as the pushbutton is being actuated, line voltage is connected to this terminal, and so the duration of the actuation can very easily be evaluated as a result of the potential difference with respect to the neutral conductor.

If the pushbutton is pressed only briefly, the operating device switches the luminous means on or off. If, with the luminous means switched on, the pushbutton is pressed for a longer time, the luminous means are dimmed upward or downward. Both in the case of short and in the case of relatively long pressing of the pushbutton, the function respectively complementary to the preceding function is executed. When the luminous means are being operated, they are switched off by a short pressure on the pushbutton. If they are switched off, they are switched on by a short pressure on the pushbutton and so on. If the luminous means are switched on, and if the pushbutton is pressed for a relatively long time, the luminous means are dimmed down. They are dimmed up again when the pushbutton is next pressed for a relatively long time. The instant from which a relatively long pushbutton pressure as such is detected, is, however, not the same on every device, because of component tolerances. Thus, it can happen that when a pushbutton is pressed exactly at the boundary between short and long pressure, the devices decide differently because of the component tolerances. Thus, one device switches off, and another interprets the pushbutton pressure as long pressure, and dims. As a consequence of this, one portion of the devices remains switched on as another switches off. During the next short pushbutton pressure, the situation is then turned around, and one portion is switched off, as the other is switched on. It is therefore then no longer possible to have all the devices switched on or all switched off. The more operating devices are actuated by one pushbutton, the higher is the probability that one or more of the operating devices fall “out of step” and display conspicuous asynchronous states.

Such asynchronisms must therefore be removed again manually by the user from time to time. This takes place by means of a special operation, for example relatively long pressure of the pushbutton with the luminous means switched off, or pressure on the pushbutton for a very long time with the luminous means switched on. In the case of a relatively long pressure on the pushbutton with luminous means switched off, the latter are switched on and are then brought to a uniform dimming level by further long pressure on the pushbutton in common with the luminous means which are already switched on, in order that all operating devices are synchronous again thereafter.

In order not to permit such asynchronisms to occur at all, some ballasts have two separate connections for the functions of switching on or dimming up and of switching off or dimming down. Therefore, this solution has the decisive disadvantage that two control lines suitable for line voltage are required to control an operating device. In the case of existing installations, this causes problems, since there is frequently only one conductor available for the control.

### OBJECT

It is an object of the invention to solve the above named problems and to make available a circuit arrangement with the aid of which the synchronization problem is solved by using only one conductor.

### SUMMARY OF THE INVENTION

The solution consists in that two pushbuttons are connected to the operating device via a line, the first pushbutton in a conventional way, and the second pushbutton via a diode. Consequently, the sinusoidal signal of the phase is provided by pressing the first pushbutton in the operating device. Upon pressure on the second pushbutton, this signal is, however, half-wave rectified. The operating device can therefore easily distinguish between the two pushbuttons and react accordingly.

By virtue of the fact that only one line from the operating point to the operating device is required as before for the inventive arrangement, the novel control method can easily be integrated into existing installations.

Since both pushbuttons are fed by the same phase, and also both switch the same power, it is possible to integrate the pushbuttons in a module with an input and an output.

The functions of “switching on/dimming up” and “switching off/dimming down” can be applied to one pushbutton each by the inventive arrangement of the switches. Synchronization problems are consigned to the past by this arrangement, since the functions of switching on and switching off lie at different pushbuttons. The operating devices are therefore synchronized on the second short pressure on the “off” pushbutton automatically, even if the first short pressure has led to an asynchronous switching off.

### BRIEF DESCRIPTION OF THE DRAWING(S)

FIG. 1 shows a circuit arrangement for the dimming control of a number of operating devices according to the prior art.

FIG. 2 shows an inventive circuit arrangement for dimming control of a number of operating devices with two pushbuttons via one line.

FIGS. 3a-d show control signals at the input of the operating devices for various actuations of the pushbuttons.

FIG. 4 shows an inventive circuit arrangement for the dimming control of a number of operating devices with three pushbuttons via one line.

### PREFERRED DESIGNS OF THE INVENTIONS

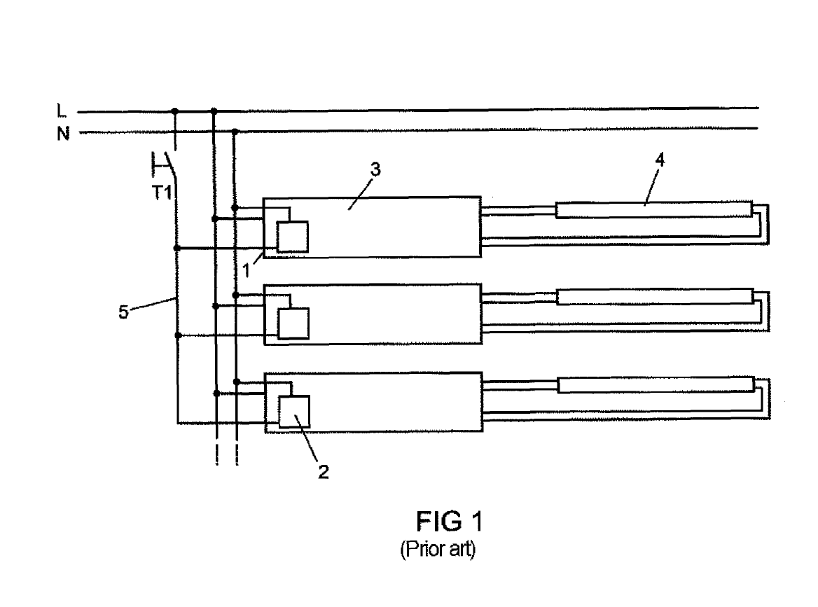

FIG. 1 illustrates the arrangement of the operating devices and of the pushbutton according to the prior art. The pushbutton T1 switches the line phase respectively to the control input 1 of the operating devices. An evaluation unit 2 establishes whether and how long the pushbutton has been pressed, and thereby controls the function of the operating device 3, which then operates the luminous means 4 with the desired power. As already mentioned at the beginning, the various functions can be retrieved via a short or a relatively long pressure on the pushbutton.

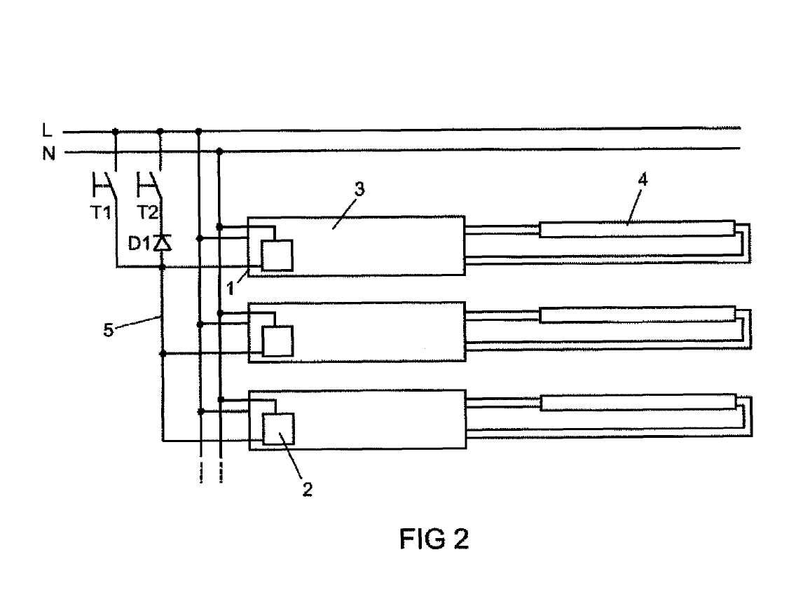

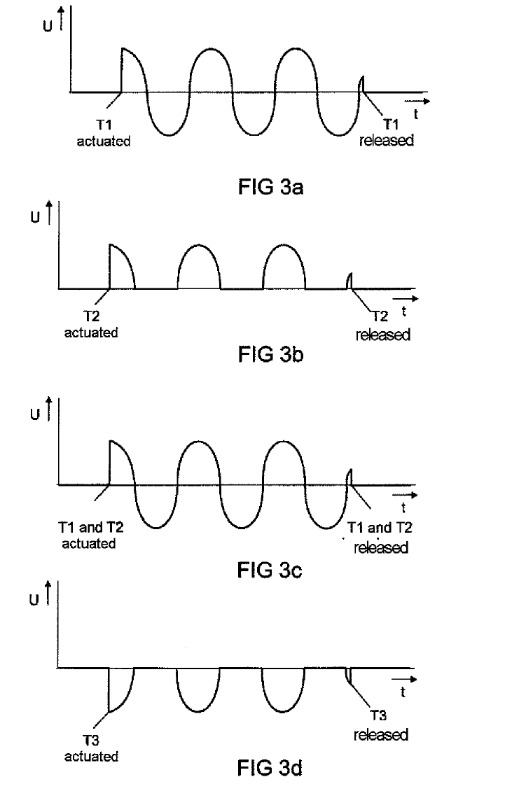

FIG. 2 illustrates the inventive circuit arrangement for the two pushbutton operation. Here, the first pushbutton T1 switches the line phase directly to the switching input of the operating device, while the second pushbutton switches the line phase to the input of the operating device via a diode. The poling of the diode is irrelevant for the inventive function. If the pushbutton 1 is now pressed, a signal according to FIG. 3a is applied at the control input of the operating device. The device thus “sees” a normal sinusoidal signal such as comes from the network. If the pushbutton 2 is now pressed, the sinusoidal signal is rectified via the diode, and so it is only the positive or the negative half waves that penetrate as far as the operating device, depending on the poling of the diode D1. This signal can appear as illustrated in FIG. 3d, for example. These two signals can be separated straight away by the operating device. Consequently, the functions that can be represented by the operating device can be divided between the two pushbuttons, and this solves the problem of the asynchronous mode of operation. These are, for example, the functions of “luminous means on” and “high dimming” on pushbutton 1, and the functions of “luminous means off” and “dimming down” on pushbutton 2. Owing to the fact that the two functions of “luminous means on” and “luminous means off” are on different pushbuttons, the synchronism problem is greatly eased. If the luminous means, for example, are switched on, and the user presses on the pushbutton 2 in such a way that a few operating devices are switched off, whereas some interpret the pushbutton pressure as “long” and allow the luminous means to be switched on, this results in an asynchronous situation. Thus, since some luminous means are still in operation, the user will once again press on the pushbutton 2, and the remaining luminous means will therefore likewise be switched off. All operating devices are thus synchronous again.

If both pushbuttons are pressed simultaneously, this results in the signal as shown in FIG. 3c. It is easy to see that this has a profile as in FIG. 3a. Thus, an automatic priority is built in for pushbutton 1 which prevents the operating devices from falling into unforeseen operating states in the event of simultaneous pressure on the two pushbuttons.

### First Embodiment

This embodiment relates to the single and two pushbutton operations of a group of operating devices via the same pilot wire.

In addition to the features described in the general part, this embodiment also has a detection function for single or two pushbutton operation. The operating device can be configured, for example, for a single pushbutton operation. Consequently, the normal functionality according to the prior art consists in that the operating device is operated with a single pushbutton. As soon as a second pushbutton is connected to the device in the inventive way, and this pushbutton is actuated for the first time, the operating device detects the new state and switches over to two pushbutton operation. The operating device very easily makes the detection, since, after all, a signal with missing half waves is present. All that the first pushbutton can now do is switch on or dim up, and the second pushbutton can do no more than switch off or dim down. All the inventive advantages of the two pushbutton operation can therefore immediately be used.

Resetting to the single pushbutton operation can be performed, for example, by a very long pushbutton pressure on pushbutton 1. The length of the pushbutton pressure is determined by the dimming period, that is to say the length that is required in order to pass from the lowest dimming stage to the highest dimming stage, or from the highest dimming stage to the lowest dimming stage, depending on which lasts longer. The length of the pushbutton pressure for resetting could then be 1.5 times the maximum dimming period, for example. However, it is also possible in this case for any other value to be applied as long, only, as it is longer than the longest dimming period.

### Second Embodiment

The second embodiment relates to the operation of two groups of operating devices via a control line. This can be advantageous, for example with relatively large installations, but also in the private domain when various luminous means are being used, for example fluorescent lamps for indirect illumination, and halogen lamps for direct light. In the case of this embodiment, the operating devices are configured such that they fundamentally implement a single pushbutton operation, but react to the various signals of the two pushbuttons. Thus, the operating devices evaluate the first signal that they have received. If it is a full wave signal from pushbutton 1, they react in future only to signals from pushbutton 1. If it is a half-wave signal from pushbutton 2, they react in future only to signals from pushbutton 2. In order to program these operating devices on site, the first group is firstly supplied with current and is trained to the first pushbutton. Thereafter, this group is separated from the network and the second group is supplied with current and is trained to the second pushbutton. All the operating devices can now be connected, and react only to “their” pushbutton.

### Third Embodiment

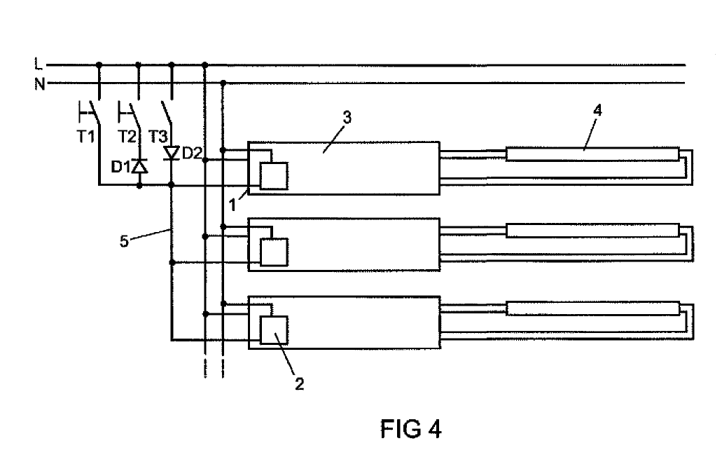

It is also possible to connect three pushbuttons to the operating device via a line: one pushbutton directly, the second via a positively connected diode, and the third via a negatively connected diode, as illustrated in FIG. 4. The operating device then distinguishes between a full-wave signal, a signal with positive half waves, and a signal with negative half waves. The functionality can be even further subdivided here. The first pushbutton T1 can, for example be used to switch the luminous means 4 on/off. The second pushbutton T2 can be used to dim up the luminous means 4, and the third pushbutton T3 to dim down the luminous means 4. This has the decisive advantage that the operating device need no longer distinguish between a long and a short pushbutton pressure, and so the problem of asynchronous operation cannot even occur at all.

### Fourth Embodiment

The three pushbutton control can, of course, also be used within the meanings of the second embodiment in order to provide a single pushbutton operation for three groups of operating devices. The designs of the second embodiment are valid here by analogy. Thus, three groups of operating devices can be driven via a single control line, and this enables a very cost-effective conversion to modern and convenient lighting engineering, especially in the case of relatively old installations.

1. A circuit arrangement for dimming control of one or more operating devices for luminous means, the operating device being controlled in the single pushbutton operation by one pushbutton which conducts line voltage via a control line to a control terminal of the operating device, and switching and dimming functions of the operating device can be executed by this pushbutton wherein a second pushbutton is connected to the control line via a diode, and the control device is then controlled in a two pushbutton operation by two pushbuttons.

2. The circuit arrangement for dimming control of one or more operating devices for luminous means as claimed in claim 1, wherein the two pushbutton operation the first pushbutton is configured for switching on and dimming up the luminous means, and the second pushbutton is configured for switching off and dimming down the luminous means.

3. The circuit arrangement for dimming control of one or more operating devices for luminous means as claimed in claim 1, wherein the operating device is configured such that it is in the single pushbutton operation until the second pushbutton is pressed for the first time, and the device switches over into the two pushbutton mode when the second pushbutton is first pressed.

4. The circuit arrangement for dimming control of one or more operating devices for luminous means as claimed in claim 2, wherein the operating device can be switched back into the single pushbutton mode by keeping the first pushbutton pressed for a comparatively long time.

5. A circuit arrangement for dimming control of one or more operating devices for luminous means, the operating device being controlled in the single pushbutton operation by a pushbutton which conducts the line voltage via a control line to a control terminal of the operating device, it being possible to execute switching and dimming functions of the operating device by this pushbutton, wherein the second pushbutton is connected to the control line via a negatively poled diode, and a third pushbutton is connected to the control line via a positively poled diode, and the operating device is then controlled in a three pushbutton operation by three pushbuttons.

6. The circuit arrangement for dimming control of one or more operating devices for luminous means as claimed in claim 5, wherein the operating device is configured such that it is in the single pushbutton operation until the second pushbutton or the third pushbutton is pressed for the first time, and the device switches over into the three pushbutton mode when the second pushbutton or the third pushbutton is first pressed.

7. The circuit arrangement for dimming control of one or more operating devices for luminous means as claimed in claim 6, wherein the operating device can be switched back into the single pushbutton mode by keeping the first pushbutton pressed for a relatively long time.

8. A circuit arrangement for dimming control of one or more operating devices for luminous means, the operating device being controlled by a pushbutton which conducts the line voltage via a control line to a control terminal of the operating device, it being possible to execute switching and dimming functions of the operating device by this pushbutton, wherein a first pushbutton and a second pushbutton are connected to the operating device via a control line, the first pushbutton being connected directly to the control line, and the second pushbutton being connected to the control line via a diode, and the operating device being configured such that it is operated either by a first pushbutton or that it is operated by the second pushbutton.

9. A circuit arrangement for dimming control of one or more operating devices for luminous means, the operating device being controlled by a pushbutton which conducts the line voltage via a control line to a control terminal of the operating device, it being possible to execute switching and dimming functions of the operating device by this pushbutton, wherein the second pushbutton is connected to the control line via a negatively poled diode, and a third pushbutton is connected to the control line via a positively poled diode, and wherein the operating device is configured such that it is operated by the first pushbutton or is operated by the second pushbutton, or is operated by the third pushbutton.

10. A method for the dimming control of one or more operating devices for luminous means, the operating device being controlled by one pushbutton which conducts the line voltage via a control line to a control terminal of the operating device, and switching and dimming functions of the operating device in a single pushbutton operation can be executed by this pushbutton, wherein after connection to the power supply the operating device is in the single pushbutton operation such that the functions of switching on, switching off, and dimming up the luminous means and dimming down the luminous means are all on one pushbutton, and the operating device switches over to a dual pushbutton operation after actuation of a second pushbutton that is connected to the control line via a diode, the functions of switching on and dimming up being assigned to the first pushbutton, and the functions of switching off and dimming down being assigned to the second pushbutton.

11. A method for the dimming control of one or more operating devices for luminous means, the operating device being controlled by one pushbutton which conducts line voltage via a control line to a control terminal of the operating device, and switching and dimming functions of the operating device in a single pushbutton operation can be executed by this pushbutton, wherein, after connection to the power supply the operating device is in the single pushbutton operation such that the functions of switching on, switching off, and dimming up the luminous means and dimming down the luminous means are all on one pushbutton, and the operating device switches over to a triple pushbutton operation after actuation of a second pushbutton that is connected to the control line via a negatively poled diode, or after actuation of a third pushbutton that is connected to the control line via a positively poled diode, the functions of switching on and switching off are assigned to the first pushbutton, and the function of dimming up being assigned to the second pushbutton, and the function of dimming down being assigned to the third pushbutton.
